(19) United States
(12) Patent Application Publication
(10) Pub. No.: US 2022/0329439 A1
(43) Pub. Date: Oct. 13, 2022

(54) METHOD FOR GENERATING DIGITAL SIGNATURES

(71) Applicant: SECURIFY BILISIM TEKNOLOJILERI VE GUVENLIGI EGT. DAN. SAN. VE TIC. LTD. STI., Yenimahalle/Ankara (TR)

(72) Inventor: Yusuf UZUNAY, Etimesgut, Ankara (TR)

(73) Assignee: SECURIFY BILISIM TEKNOLOJILERI VE GUVENLIGI EGT. DAN. SAN. VE TIC. LTD. STI., Yenimahalle/Ankara (TR)

(21) Appl. No.: 17/627,769

(22) PCT Filed: Aug. 5, 2019
(86) PCT No.: PCT/TR2019/050648

§ 371 Date: Jan. 17, 2022

(51) Int. Cl. H04L 9/32; H04L 9/08; H04L 9/06

(52) U.S. Cl. CPC H04L 9/3247; H04L 9/0869; H04L 9/0643; H04L 2209/20

(57) ABSTRACT

A method for generating digital signatures is disclosed. The method contains the steps of generating at least one private key, generating at least one table by using the private key in at least one white box cryptosystem, generating at least one random number, generating pre images, each to be used in a digital signature by encrypting the random numbers using the generated table in at least one white box cryptosystem, and generating at least one digital signature by using at least one generated pre image.

### TECHNICAL FIELD

The present invention is related to a method for generating digital signatures using white box cryptography.

### PRIOR ART

In the digital world, it is easy to modify soft digital files (soft copy documents). Although this feature is advantageous in different aspects (for example correcting an error becomes easy), said feature also causes security issues. Since it is easy to modify digital files, determining the authenticity of a digital file becomes troublesome. In order to solve this problem, different authentication applications are used.

One of the authentication applications used in the art is usage of digital signatures. In these applications, files are signed with a private key to obtain digital signatures. These signatures prevent modification of the files without the knowledge of the private key. Therefore, digitally signed files are considered to be as authentic as hard copy files.

In order to trust the authenticity of a digitally signed document, used digital signature must be a secure one. In other words, an attacker (such as a malicious third party) should not generate a valid digital signature for a modified (forged) file.

In order to provide necessary security for digital file by preventing an attacker to generate a digital signature, a variety of digital signatures could be used. In all these applications, all files are signed with a single private key. The holder of the private key could generate a digital signature for any file he wants. Although digital signatures solve above mentioned security problems, protecting the private key against attackers remains a challenge.

This challenge of protecting the cryptographic keys is more evident in implementations where an attacker has the full control of the execution environment. White-box cryptography (Ref: Chow, Stanley, et al. “White-box cryptography and an AES implementation.” International Workshop on Selected Areas in Cryptography. Springer, Berlin, Heidelberg, 2002.) aims at providing a practical degree of protection against these so-called white-box attacks. While, white-box cryptosystems for symmetric key encryption are studied extensively, as far as digital signatures are of concern we see that only a few white-box proposals do exist. One exemplary embodiment for such application is disclosed in patent document CN106612182A.

Unlike conventional digital signature algorithms like RSA (Rivest, Ronald L., Adi Shamir, and Leonard Adleman. “A method for obtaining digital signatures and public-key cryptosystems.” Communications of the ACM 21.2 (1978): 120-126.), one-time digital signatures allow to generate signatures without heavy public key operations like modular exponentiation. It simply works first by generating pre images and then computing hash value of these as the hash images. The one-time digital signature of a given message is just a computed subset of pre images which can be easily verified by receivers by computing the hash of these and compare them with the already received hash image values. Although, the one-time digital signature concept is well-known and well-understood, the challenge of improving its security against a white-box attacker has not been explored previously.

### BRIEF DESCRIPTION OF THE INVENTION

The present invention provides a method for generating digital signatures. Said method comprises the steps of, generating at least one private key; generating at least one table by using said private key in at least one white box cryptosystem; generating at least one random number; generating pre images, each of which to be used in a digital signature, by encrypting said random numbers using the generated table in at least one white box cryptosystem; generating at least one digital signature by using at least one generated pre image.

According to the present invention, digital signatures are generated using at least one private key in a white box cryptosystem. Moreover, for the generation of each of the pre images, to be used as digital signatures, random numbers are used. Therefore, according to the present invention, unlimited numbers of pre images are able to be generated using a single private key. Moreover, due to the nature of the white box cryptography and usage of random numbers, the private key is protected against possible attackers.

### Object of the Invention

The object of the invention is to provide a method for generating digital signatures.

Another object of the invention is to provide a method for generating one time digital signatures.

Another object of the invention is to provide a method for generating digital signatures using white box cryptosystem.

Another object of the invention is to provide a secure method for generating digital signatures.

Another object of the invention is to provide a method for generating multitude of (possibly infinite number of) one time digital signatures.

### DESCRIPTION OF THE DRAWINGS

FIG. 1 shows a flow diagram of the digital signature generation method of the invention.

The references in the figures may possess following meanings;
Message (M)
Generating private key (101)
Generating table (102)
Generating random number (103)
Generating pre images (104)
Signing (105)
Generating hash images (106)
Deleting private key (107)
Erasing pre image (108)

### DESCRIPTION OF THE INVENTION

One of the methods for authenticating digital files is signing said files with digital signatures. In order to guarantee the authenticity of a digitally signed document, used digital signature must be a secure one. In other words, an attacker should not have access to the private key used in said digital signature. In order to enhance the security of the digital signatures against the possible attackers or for variety of other reasons, hash-function based one time digital signatures could be preferred. Although one time digital signatures hold various advantages, protecting security of the private key is troublesome. Therefore, according to the present invention, a method for generating the digital signature and protecting private key is provided.

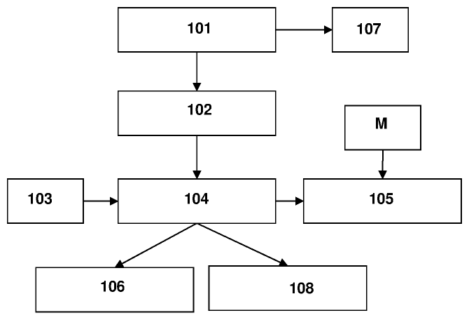

Digital signature generation method of the present invention, a flow diagram of which is given in FIG. 1, comprises the steps of, generating at least one private key (101); generating at least one table (102) by using said private key in at least one white box cryptosystem; generating at least one random number (103); generating pre images (104), each of which to be used in a digital signature, by encrypting said random numbers using the generated table in at least one white-box cryptosystem; generating at least one digital signature by using at least one generated pre image.

In an exemplary embodiment of the present invention, a private key (for example a symmetric key) is generated by any methods known in the art. In at least one white box cryptosystem, at least one table is generated by using said private key. In other words, by performing at least one known table generation method in a known white box cryptography method on the private key, said table is generated. At least one random number is generated. By using the generated table, said random numbers are encrypted. As a result of said encryption process, plurality of pre images are generated. In detail, each of the said pre images are generated by encrypting a random number with the generated table and the chosen white-box crypto system. One of the white-box crypto system is given in Bogdanov, Andrey, and Takanori Isobe. “White-box cryptography revisited: space-hard ciphers.” Proceedings of the 22nd ACM SIGSAC Conference on Computer and Communications Security. ACM, 2015. Generated pre images are used in a digital signature. For example, a message (M) is able to be signed (105) using said pre images. According to the present invention, since plurality of pre images are generated by using a private key, each of said pre images are able to be used in one time digital signatures.

In a preferred embodiment of the present invention, said method comprises the step of deleting the private key (107) after the step of generating table (102). Since the private key is only used for generating table (102), said private key has no use after the table is generated. Therefore, in order to eliminate the risk of un-authorized access to the private key by a malicious third party, private key is deleted securely.

In another preferred embodiment of the present invention, step of generating at least one table (102) by using said private key in at least one white box cryptosystem may be repeated using at least one different white box cryptosystem. In this embodiment, by using different white box cryptosystem, different table is generated. Therefore, number of generated pre images are increased.

In another preferred embodiment of the present invention, said method comprises the step of generating hash images (106) by standard hashing operation (for example by using SHA-256 algorithm) the pre images. In this embodiment, a hash image is generated for each of the pre images. When a pre image is used as a digital signature, hash image corresponding to said pre image is used as public key for said digital signature. Therefore, any third party is able to examine the authenticity of a signed message (M) using the hash images (due to the nature of hashing algorithms, a hash image corresponds to a pre image).

By increasing the number of pre-images and hash images and assigning special pre-images and message (M) relations, virtually unlimited number of digital signatures corresponding to unlimited number of different messages (M) could be generated. One of the known applications for this type of relation (digital signature and public key relation) is given in Buchmann, Johannes, et al. “Merkle signatures with virtually unlimited signature capacity.” International Conference on Applied Cryptography and Network Security. Springer, Berlin, Heidelberg, 2007.

In another preferred embodiment of the present invention, step of generating at least one random number (103) comprises the steps of, generating at least one random seed; adding at least one counter value to generated seed to generate at least one random number. In this embodiment, the counter value is preferably increased by one for the generation of a new random number. In an exemplary embodiment, the counter value is 0 for generating a first random number; the counter value is 1 for generating a second random number and this goes on until all random numbers are generated.

In another preferred embodiment of the present invention, said method comprises the step of erasing at least one pre image (108) used in at least one digital signature, after the step of generating at least one digital signature by using at least one generated pre image. By this way, the white-box attacker could only access the pre images in a short amount of time (just after pre images are generated but before they are used). Note that the white-box attacker could not access the private key in any way. Generating the pre images just before they are used and erasing them shortly after reduces significantly the damage caused by a white-box attacker.

According to the present invention, digital signatures are generated using at least one private key in a white box cryptosystem (the private key of the digital signature corresponds to the symmetric key of the white box cryptosystem). Moreover, for the generation of each of the pre images, to be used as digital signatures, a random number is used as well. Therefore, according to the present invention, unlimited numbers pre images are able to be generated using a single private key. Moreover, due to the nature of the white box cryptography and usage of random numbers, each of the pre images are protected against possible attackers.

1. A method for generating digital signatures characterized by comprising the steps of;
generating at least one private key (101);
generating at least one table (102) by using said private key in at least one white box cryptosystem;
generating at least one random number (103);
generating pre images (104), each of which to be used in a digital signature, by encrypting said random numbers using the generated table in at least one white-box cryptosystem
generating at least one digital signature by using at least one generated pre image.

2. The method according to claim 1, wherein said method further comprises the step of deleting the private key (107) after the step of generating table (102).

3. The method according to claim 1, wherein step of generating at least one table (102) by using said private key in at least one white box cryptosystem is repeated using at least one different white box cryptosystem.

4. The method according to claim 1, wherein said method further comprises the step of generating hash images (106) by hashing the pre images which corresponds to one-time public key to be used to verify one-time digital signature.

5. The method according to claim 4, wherein SHA-256 algorithm used for generating hash images (106).

6. The method according to claim 1, wherein step of generating at least one random number (103) comprises the steps of, generating at least one random seed; adding an output at least one counter to generated seed to generate at least one random number.

7. The method according to claim 1, wherein said private key is a symmetric key.

8. The method according to claim 1, wherein said method further comprises the step of erasing at least one pre image (108) used in at least one digital signature, after the step of generating at least one digital signature by using at least one generated pre image
